(19) United States
(12) Patent Application Publication
(10) Pub. No.: US 2026/0351708 A1
(43) Pub. Date: Nov. 5, 2026

(54) Device for Regulating the Temperature of Battery Cells

(71) Applicant: N-Solutions s.r.o., Stare Mesto (CZ)

(72) Inventor: Tomas Novacek, Uherske Hradiste (CZ)

(73) Assignees: Qoolers s. r. o., Stare Mesto (CZ); N-Solutions s.r.o., Stare Mesto (CZ)

(21) Appl. No.: 19/116,367

(22) PCT Filed: Sep. 26, 2023
(86) PCT No.: PCT/CZ2023/050061

§ 371 Date: Mar. 28, 2025

(30) Foreign Application Priority Data
Sep. 29, 2022 (CZ) PV 2022-413

(51) Int. Cl. H01M 10/617; H01M 10/613; H01M 10/643; H01M 10/6556; H01M 10/6567; H01M 50/213; H01M 50/271; H01M 50/291; H01M 50/293

(52) U.S. Cl. CPC H01M 10/617; H01M 10/613; H01M 10/6556; H01M 10/6567; H01M 50/271; H01M 50/291; H01M 50/293; H01M 10/643; H01M 50/213

(57) ABSTRACT

A device for regulating temperature of battery cells comprising a casing, a cover, a cavity inside the casing, at least one inlet of a heat transfer medium into the cavity and at least one outlet of the heat transfer medium from the cavity, wherein at least 3 battery cells are located in the cavity and surrounded by the heat transfer medium, wherein the cavity has a mouth adjacent to a first side of the casing closed by the cover. The device further comprises an elastic plate, wherein the elastic plate comprises a number of openings corresponding to the number of battery cells inside the cavity, where each battery cell passes through one opening. The cover comprises electrical conductors connected to the battery cells and is adjacent to the first side of the elastic plate, wherein the second side of the elastic plate is in contact with the heat transfer medium.

### TECHNICAL FIELD

The invention relates to a device for storing and regulating the temperature of a number of battery cells using a heat transfer medium, which solves the problems associated with the fixing and sealing of the individual elements of the device and the uneven cooling of the battery cells.

### BACKGROUND OF THE INVENTION

Lithium battery cells, and in particular battery modules (batteries) composed of them, are a widely used source of long-life energy. A disadvantage of lithium batteries is their high sensitivity to temperature changes and especially overheating, which causes fluctuations in battery capacity and performance, excessive discharge or overcharging of battery cells, and can eventually lead to short circuit and destruction of the entire battery module.

In the current state of the art, units for storing battery cells that are cooled by the flowing of a cooling medium are known. In the document EP3363061 B1 is described a device comprising two sealing grids strung on battery cells, wherein a cooling liquid flows between the sealing grids and a circumferential frame. A disadvantage of this solution is the lack of protection of the sealing grids and battery cells from movement due to the pressure of the cooling liquid, wherein the position of the battery cells is not otherwise fixed.

The document DE102014112628 A1 describes a cooling battery module that comprises a frame and two sealing plates through which battery cells are threaded, wherein a cooling liquid flows between the sealing plates. The distance between the sealing plates and their mutual cohesion is ensured by a number of pads, which are attached to the sealing plates and the frame by screwed, glued, or welded connections. Said arrangement comprises a number of auxiliary connecting elements that unnecessarily take up space between the battery cells and must be fixed by a large number of connections. In addition, the position of the sealing plates is not ensured over their entire surface, but only at points, resulting in uneven protection of the sealing plates from the pressure of the cooling liquid.

The document JP2012009388 A describes a casing of battery cells cooled indirectly by means of cooling frames that are inserted between each row of battery cells and comprise conduction of cooling liquids. A number of cooling frames are connected to the support frame with screws. This spatial arrangement is inefficient, as the cooling frames take up a large part of the internal space of the casing that could be filled by additional battery cells. The cooling efficiency is small because the cooling by the cooling liquid does not occur by direct contact with the battery cells for most of their surface area, and the direction of the flowing of the cooling liquid is rigidly determined by the conduction of the cooling medium through a narrow channel.

A disadvantage of the above solutions is that the position of the battery cells and sealing elements in the device is ensured only at points or with the use of a large number of connections and auxiliary elements, wherein when placed in the device cavity these connecting and auxiliary elements unnecessarily take up space potentially usable for other battery cells. If the sealing elements and battery cells are not stabilised properly, they are unevenly stressed by the pressure of the cooling medium, wherein untightness or other failures may occur in the affected regions. Another disadvantage of the prior state of the art is the lack of use of the heat exchanger structure for the structure of the casing of the battery cells, or for their protection and thermal insulation. Furthermore, there is no solution that would solve the above shortcomings at the same time as making it easier to assemble such a heat exchanger structure with a casing function.

### SUMMARY OF THE INVENTION

The above shortcomings are to some extent eliminated by a device for regulating the temperature of battery cells of the present invention, wherein the device comprises a casing, a cover, a cavity inside the casing, at least one inlet of a heat transfer medium into the cavity, and at least one outlet of the heat transfer medium from the cavity, wherein the battery cells are located in the cavity and surrounded by the heat transfer medium. The casing comprises a first side of the casing and a second side of the casing and the cavity has a mouth adjacent to the first side of the casing enclosed by the cover, wherein the device further comprises an elastic plate that comprises a number of openings corresponding to the number of battery cells inside the cavity, where each battery cell passes through one opening and the cross-section of the openings in the elastic plate is as large or smaller than the cross-section of the battery cells, wherein the cover comprises electrical conductors connected to the battery cells and is adjacent to the first side of the elastic plate, wherein the second side of the elastic plate is in contact with the heat transfer medium.

The rigid connection of the elastic plate to the cover and the casing of the device eliminates possible displacements of the battery cells and the elastic plate due to the pressure of the heat transfer medium, since the position of the elastic plate and the battery cells in the openings of the elastic plate is held by the cover over most of the surface area of the elastic plate. The cavity of the device is fully utilised to store the battery cells, which are rigidly fixed between the casing and the cover and connected to the electrical conductors on the cover. The device is optimised to store and safely regulate the temperature of a maximum number of battery cells in the cavity, wherein no additional reinforcing or connecting elements need to be used. At the same time, the device of the invention makes optimal use of its structure to provide thermal insulation and protection of the battery cells from external influences, thus fulfilling the functions of a full-fledged casing. Moreover, the device of the invention can be easily constructed.

The device for regulating the temperature of battery cells preferably comprises electrical conductors adjacent to an elastic plate, wherein the electrical conductors are part of the cover and the cover is composed only of components necessary for safe connection of the contacts of the battery cells. Said arrangement allows the electrical contacts to function as elements for fixing the position of the elastic plate, protecting the elastic plate, and closing the casing without the need for another component.

The device for regulating the temperature of battery cells preferably comprises an inlet of the heat transfer medium and an outlet of the heat transfer medium that are located on opposite sides of the casing, which contributes to even flowing of the heat transfer medium through the entire cavity of the device and cooling of the battery cells. The device may comprise multiple such pairs of inlets and outlets of the heat transfer medium.

The casing of the device for regulating the temperature of battery cells preferably comprises at least one integrated channel connecting the cavity to the inlet of the heat transfer medium or the outlet of the heat transfer medium. An advantage of the integrated channel in the device cavity is the directing of the flow of the heat transfer medium in the selected direction, wherein the secondary function of the integrated channel is the function of reinforcement, which would otherwise have to be performed by additional elements in the device cavity, e.g., reinforcing ribs, which unnecessarily take up space in the cavity.

The casing of the device for regulating the temperature of battery cells preferably comprises one integrated channel connected to the inlet of the heat transfer medium and one integrated channel connected to the outlet of the heat transfer medium. In the case of an embodiment of the casing with two integrated channels, regulation of the flowing of the heat transfer medium at the inlet and outlet is achieved, as one integrated channel serves as the inlet and the other as the outlet.

The casing of the device for regulating the temperature of battery cells preferably comprises integrated channels in its circumferential lateral walls at a level between the first and second sides of the casing, wherein the integrated channels comprise penetrations into the cavity. The integrated channels with penetrations regulate the direction of the flowing of the heat transfer medium to multiple battery cells in different parts of the cavity and at the same time the whole device is evenly reinforced.

In a preferred embodiment, the elastic plate is sandwiched between the cover and the first side of the casing around its circumference, wherein the cover is in contact with the first side of the casing, the first side of the elastic plate, and the battery cells. By sandwiching the elastic plate between the casing and the cover around its entire circumference, implementation of point connections between the cover, elastic plate, and casing is eliminated.

The bottom of the device cavity preferably comprises hitches adapted to the shape of the battery cells for locking the battery cells in place, the spacing or connection of the battery cells to the casing. Fixing the battery cells to the casing of the device using shape elements increases the cohesion of the battery cells with the casing and reduces the risk of battery cell loosening or other failures due to the pressure of the flowing liquid.

The bottom of the cavity further preferably comprises a reinforcing element passing through the cavity and a corresponding opening in the elastic plate for rigid connection of the bottom of the cavity to the cover. The reinforcing element further increases the cohesion of the cover with the casing.

### CLARIFICATION OF THE DRAWINGS

A summary of the invention is further clarified by example embodiments thereof, which are described using the accompanying drawings, in which:

FIG. 1 shows a view of the device for regulating the temperature of battery cells of the invention,

FIG. 2 shows a longitudinal section of the device for regulating the temperature of battery cells of the invention,

FIG. 3 shows a lateral view of the device for regulating the temperature of battery cells of the invention,

FIG. 4 shows a top view of the device for regulating the temperature of battery cells of the invention,

FIG. 5 shows a vertical cross section of the device for regulating the temperature of battery cells of the invention.

### EXEMPLARY EMBODIMENTS OF THE INVENTION

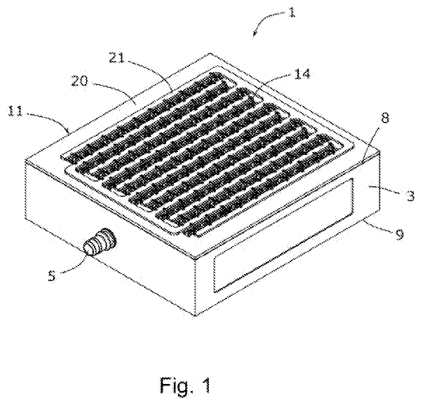

The invention will be further clarified by example embodiments with reference to the respective drawings. One example of an embodiment is the device 1 for regulating the temperature of battery cells 2 shown in FIGS. 1 to 5.

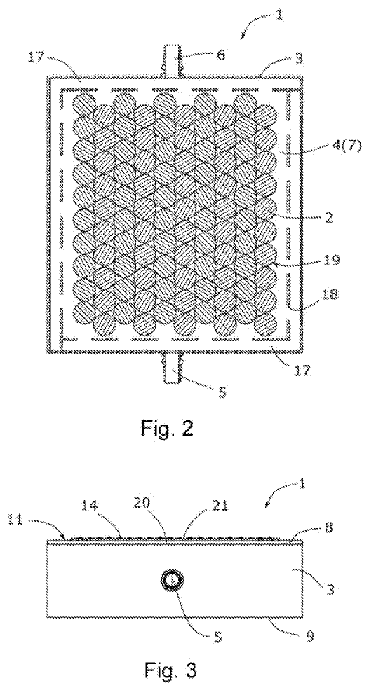

The device 1 for regulating the temperature of battery cells 2 comprises an external casing 3 in the shape of a flat cuboid (FIG. 1) and a cavity 4 inside the casing 3, in which a number of battery cells 2 surrounded by a heat transfer medium Z are located. The inlet 5 of the heat transfer medium into the cavity 4 and the outlet 6 of the heat transfer medium from the cavity 4 are located symmetrically on opposite sides of the casing 3 in the centre of the circumferential lateral walls (FIGS. 2 to 4). The inlet and outlet 5,6 of the heat transfer medium means the passage of the heat transfer medium Z into the cavity 4 of the device with an elongated mouth for connecting hoses that supply or discharge the heat transfer medium 7, which in this case is a cooling liquid. The casing 3 of the device and both the inlet and outlet 5,6 of the heat transfer medium are made of polymers or polymer-, carbon-, or Kevlar-based composites. At the location where the electronic unit of the battery system is stored, the thickness of the wall of the casing 3 is reduced such that the electronic unit of the battery system can be cooled more efficiently. The electronic unit of the battery system is the BMS (Battery Management System, balancer).

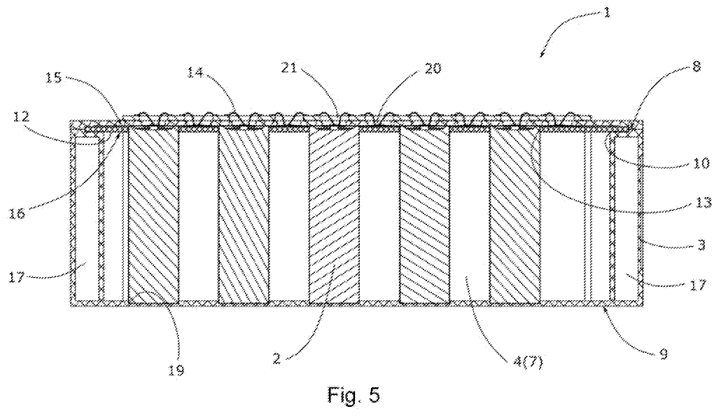

The casing 3 of the device comprises a first side 8 of the casing and a second side 9 of the casing, wherein the cavity 4 has a mouth 10 on the first side 8 of the casing closed by a cover 11. On the opposite side from the mouth 10 of the cavity, that is, closer to the second side 9 of the casing, in this exemplary embodiment, the bottom of the cavity 4 is located. The casing 3 comprises in its circumferential lateral walls two L-shaped integrated channels 17, wherein each integrated channel 17 is part of two adjoining lateral walls of the casing 3. One integrated channel 17 connects the cavity 4 to the inlet 5 of the heat transfer medium, and the second integrated channel 17 connects the cavity 4 to the outlet 5 of the heat transfer medium. The integrated channels 17 have a rectangular cross-section, wherein the height of the cross-section is equal to the height of the cavity 4 between the first and second sides 8,9 of the casing, and the width of the cross-section is approximately equal to the diameter of the opening of the inlet and outlet 5,6 of the heat transfer medium. Each integrated channel 17 comprises penetrations 18 in its wall, which are oriented in the space of the cavity 4 between the battery cells 2. Each integrated channel 17 in this embodiment comprises 10 penetrations 18 evenly spaced along the entire length of the integrated channel 17. The integrated channel 15 connected to the inlet 5 of the heat transfer medium and the integrated channel 17 connected to the outlet 6 of the heat transfer medium are separated from each other. The embodiment of the integrated channels 17 is shown in sections of the device 1 in FIGS. 2 and 5.

In the first exemplary embodiment, the device 1 comprises a total of 100 vertically oriented cylindrical battery cells 2 that are arranged in 10 rows of 10 battery cells 2 in the cavity 4 as can be seen in FIG. 2. The battery cells 2 directly abut the bottom of the cavity 4 adjacent to the second side 9 of the casing, wherein the bottom of the cavity 4 comprises hitches 19 adapted to the shape of the battery cells for locking the battery cells 2 in place. The hitches 19 are thus adapted to a precise placement and fixation of the position of the battery cells 2 relative to the casing 3. In the first exemplary embodiment, they are flat depressions at the bottom of the cavity 4 in the shape of a circle corresponding to the external shape of the battery cells 2, wherein the battery cells 2 are seated in these depressions and rigidly connected to the casing 3. The battery cells 2 are arranged in close proximity to each other, but with a spacing allowing the flowing of the heat transfer medium 7 surrounding the battery cells 2. The battery cells 2 comprise an electrical insulation at the location of contact with the heat transfer medium 7, and the two contacts (poles) of the battery cells 2 are located closer to the mouth 10 of the cavity on the first side 8 of the casing (on the top side of the battery cells 2).

An elastic plate 12 is seated on the casing 3 of the device and the number of battery cells 2 at the level of the mouth 10 of the cavity. The elastic plate 12 comprises a number of openings 13 corresponding to the number of battery cells 2, wherein the arrangement of the openings 13 in the elastic plate 12 is analogous to the arrangement of the hitches 19 at the bottom of the cavity 4 of the device and each battery cell 2 passes through one opening 13 of the elastic plate. The elastic plate 12 is made of a flexible elastomeric material possibly reinforced with textile fibres, wherein to ensure compression and tightness of the elastic plate 12 around the battery cells 2, the diameter of the openings 13 in the elastic plate 12 is smaller than the external diameter of the battery cells 2.

Directly on the elastic plate 12 the cover 11 is seated, wherein the first side 15 of the elastic plate is adjacent to the cover 11 and the second side 16 of the elastic plate is in contact with the heat transfer medium Z that fills the space of the cavity 4 around the battery cells 2. The elastic plate 12 is also partially adjacent with its second side 16 to the first side 8 of the casing, wherein it is sandwiched along its circumference between the first side 8 of the casing and the cover 11. The sandwiching of the elastic plate 12 between the cover 12 and the first side 8 of the casing is located on the walls of the integrated channels 17, as can be seen in FIG. 5. The rigid connection of the cover 11 to the casing 3 is provided by a pressed, screwed, glued, or welded connection, wherein the surface connection of the cover 11 to both the elastic plate 12 and the casing 3 helps to maintain the pressure on the elastic plate 12, its position, and its sealing ability.

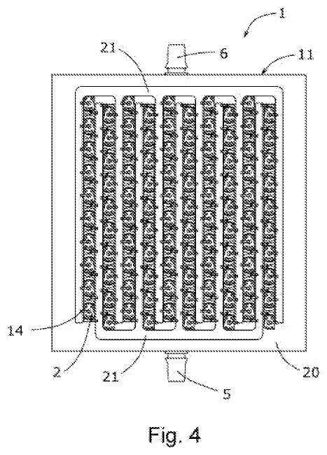

The cover 11 adjacent to the first side 15 of the elastic plate is, in the first exemplary embodiment, composed of 3 rigidly connected pieces comprising a carrier 20 and further two electrically conductive and mutually separated (insulated) switchboards 21 to which the electrical conductors 14 are connected. The carrier 20 is made of a non-conductive material (polymer) in the form of a plate that is adjacent to the first side 15 of the elastic plate, the battery cells 2, and, along its circumference, also to the casing 3. On the opposite side from the elastic plate 12, two switchboards 21 with electrical conductors 14 are adjacent to the carrier 20, wherein the carrier 20 isolates these switchboards 21 from direct contact with the battery cells 2. Both switchboards 21 with electrical conductors 14 are electrically conductive metallic shaped elements (see FIG. 4), wherein one switchboard 21 comprises electrical conductors 14 connected to the positive poles of the battery cells 2 and the other switchboard 21 comprises electrical conductors 14 connected to the negative poles of the battery cells 2, wherein one of the poles (contacts) is located in the centre of the battery cell 2 and the other of the poles is located on the edge of the battery cell 2. The connections of the electrical conductors 14 to the contacts of the battery cells 2 are made, e.g., by point welding, soldering, or mechanical connection, wherein the electrical conductor 14 is connected to at least one contact of the battery cell 2 by a fuse wire that serves as a fuse in case of a short circuit of the battery cell 2. The electrical conductors 14 connecting the switchboard 21 to the contacts of the electrical cells 2 are routed through the cutouts in the carrier 20 of the cover (seen in the section in FIG. 5), wherein a secondary function of the metallic switchboards 21 is to reinforce the entire cover 11.

All rigid connections of the elements of the device 1, e.g., the connection of the battery cells 2 to the hitches 19 on the bottom of the cavity 4, or of the cover 11 to the casing 3 of the device, are made as pressed, screwed, glued, welded, shape, or mechanical connections.

In an alternative embodiment, the casing 3 of the device may be made of other composite materials and reinforced with metallic inserts or ribs. Alternatively, it can be made of metals or their alloys and subsequently provided with insulation. The casing 3 can be of any shape, e.g., a cuboid, a prism, or a cylinder.

In an alternative embodiment, the device 1 may comprise both an inlet and an outlet 5,6 of the heat transfer medium on one (the same) side of the casing 3, including the first side 8 of the casing. In another embodiment, it may comprise two inlets 5 of the heat transfer medium and two outlets 6 of the heat transfer medium, wherein one inlet 5 of the heat transfer medium and one outlet 6 of the heat transfer medium are located on each of the two opposite sides of the device 1. The outlet 6 of the heat transfer medium may be designed only as an outlet opening or outlet chamber without connection to the integrated channel 17. Parameters of the integrated channels 17 such as the diameter of the integrated channel 17, the number of penetrations 18, or the size of the penetrations 18 can be adapted in terms of the direction, velocity, and pressure of the heat transfer medium Z during the flowing through the device 1. The inlet and outlet 5,6 of the heat transfer medium, or more generally the casing 3 of the device, may comprise a temperature or pressure sensor or a bleed valve.

In an alternative embodiment of the cover 11, the cover 11 may comprise only 2 electrically insulated switchboards 21 without the carrier 20, wherein the switchboards 21 directly abut the casing 3 and the first side 15 of the elastic plate and the electrical insulation of both switchboards 21 is provided by the shaping of the elastic plate 12. The electrical conductors 14 may also be a direct part of the metallic moulding of the switchboard 11 as protrusions of this moulding, which are connected at points to the poles of the battery cells 2.

An alternative embodiment of the hitches 19 on the bottom of the cavity 4 may comprise, in addition to the shaped depressions, grooves or, conversely, projections which project above the level of the bottom of the cavity 4 and between which the battery cells 2 are rigidly seated.

In an alternative embodiment, the bottom of the cavity 4 may comprise one or more reinforcing elements passing through the cavity 4 and corresponding openings in the elastic plate 12 for rigidly connecting the bottom of the cavity 4 to the cover 11. This reinforcing element may also replace 1 or more battery cells 2, in particular at locations where it is desirable to increase the cohesion of the cover 11 with the casing 3.

In another embodiment of the device 1 of the present invention, the cavity 4 of the device may also comprise a mouth 10 on the second side 9 of the casing. Thus, in this embodiment, the casing 3 of the device comprises only the circumferential lateral walls and the device 1 comprises two elastic plates 12 and two covers 11, wherein one elastic plate 12 is adjacent to the casing 3 and the battery cells 2 from the first side 8 of the casing and the second elastic plate 12 is adjacent to the casing 3 and the battery cells 2 from the second side 9 of the casing. The cover 11 is then adjacent to each of the elastic plates 12, wherein the electrical conductors 14 may be located on only one of the two covers 11 or on both covers 11 depending on the orientation of the contacts of the battery cells 2. In this embodiment, the battery cells 2 and the heat transfer medium Z surrounding the battery cells 2 are sandwiched between the two elastic plates 12 and the covers 11.

### INDUSTRIAL APPLICABILITY

The above described device can further be used for entire systems of units for regulating the temperature of battery cells.

### LIST OF REFERENCE NUMERALS

1—device
2—battery cell
3—casing
4—cavity
5—inlet of the heat transfer medium
6—outlet of the heat transfer medium
7—heat transfer medium
8—first side of the casing
9—second side of the casing
10—mouth of the cavity
11—cover
12—elastic plate
13—opening
14—electrical conductor
15—first side of the elastic plate
16—second side of the elastic plate
17—integrated channel
18—penetration
19—shape element
20—carrier
21—switchboard

1. A device for regulating a temperature of battery cells comprising a casing, a cover, a cavity inside the casing, at least one inlet of a heat transfer medium into the cavity, and at least one outlet of the heat transfer medium from the cavity, wherein at least three battery cells are located in the cavity and surrounded by the heat transfer medium, wherein the casing comprises a first side of the casing and a second side of the casing and the cavity has a mouth on the first side of the casing closed by the cover, the device further comprising an elastic plate, wherein the elastic plate comprises a number of openings corresponding to the number of battery cells inside the cavity, where each battery cell passes through one opening and a cross-section of the openings in the elastic plate is as large or smaller than a cross-section of the battery cells, wherein the cover comprises electrical conductors connected to the battery cells and is adjacent to the first side of the elastic plate, wherein the second side of the elastic plate is in contact with the heat transfer medium, wherein the elastic plate is at least partially deformed along a circumference thereof between the cover and the first side of the casing.

2. The device for regulating the temperature of battery cells of claim 1, wherein the electrical conductors are adjacent to the elastic plate.

3. The device for regulating the temperature of battery cells of claim 1, further comprising the inlet of the heat transfer medium and the outlet of the heat transfer medium, which are located on opposite sides of the casing.

4. The device for regulating the temperature of battery cells of claim 1, wherein the casing comprises at least one integrated channel connecting the cavity to the inlet of the heat transfer medium or the outlet of the heat transfer medium.

5. The device for regulating the temperature of battery cells of claim 4, wherein the casing comprises one integrated channel connected to the inlet of the heat transfer medium and one integrated channel connected to the outlet of the heat transfer medium.

6. The device for regulating the temperature of battery cells of claim 5, wherein the casing comprises integrated channels in its circumferential lateral walls at a level between the first and second sides of the casing, wherein the integrated channels comprise penetrations into the cavity.

7. (canceled)

8. The device for regulating the temperature of battery cells of claim 1, wherein the bottom of the cavity comprises hitches adapted to the shape of the battery cell for locking the battery cells in place.

9. The device for regulating the temperature of battery cells of claim 1, wherein the bottom of the cavity comprises a reinforcing element passing through the cavity and a corresponding opening in the elastic plate for rigidly connecting the bottom of the cavity to the cover.

10. The device for regulating the temperature of battery cells of claim 1, wherein the elastic plate is made of a flexible elastomeric material to ensure compression and tightness around the battery cells, the cross-section of the openings in the elastic plate being smaller than the cross-section of the battery cells.
